(19) United States
(12) Patent Application Publication
(10) Pub. No.: US 2026/0343100 A1
(43) Pub. Date: Oct. 29, 2026

(54) INFORMATION PROCESSING APPARATUS, CONTROL DEVICE, INFORMATION PROCESSING METHOD, AND INFORMATION PROCESSING PROGRAM

(71) Applicant: FUJIFILM Corporation, Tokyo (JP)

(72) Inventors: Tetsuya FUJIKAWA, Saitama (JP); Masahiko SUGIMOTO, Saitama (JP); Tomoharu SHIMADA, Saitama (JP)

(73) Assignee: FUJIFILM Corporation, Tokyo (JP)

(21) Appl. No.: 19/653,123

(22) Filed: Apr. 21, 2026

Related U.S. Application Data
(63) Continuation of application No. PCT/JP2024/036674, filed on Oct. 15, 2024.

(30) Foreign Application Priority Data
Oct. 30, 2023 (JP) 2023-185446

(51) Int. Cl. H04N 23/695; H04N 23/661; H04N 23/67

(52) U.S. Cl. CPC H04N 23/695; H04N 23/67; H04N 23/661

(57) ABSTRACT

An information processing apparatus includes: a processor that is communicable with an imaging apparatus and a revolution device causing the imaging apparatus to revolve, and the processor is configured to: acquire first position information based on a revolution condition of the revolution device corresponding to a first subject; acquire second position information based on a revolution condition of the revolution device corresponding to a second subject; acquire third position information based on a revolution condition of the revolution device corresponding to a third subject; and output distance information between the first subject and one of the second subject or the third subject based on the first position information, the second position information, and the third position information.

### CROSS REFERENCE TO RELATED APPLICATION

This is a continuation of International Application No. PCT/JP2024/036674 filed on Oct. 15, 2024, and claims priority from Japanese Patent Application No. 2023-185446 filed on Oct. 30, 2023, the entire disclosures of which are incorporated herein by reference.

### BACKGROUND OF THE INVENTION

### 1. Field of the Invention

The present invention relates to an information processing apparatus, a control device, an information processing method, and a computer readable medium storing an information processing program.

### 2. Description of the Related Art

JP3220181Y discloses an aerial line imaging apparatus and an imaging apparatus that comprise a telescope that views an aerial line, a video camera device that captures an image of the aerial line, a pan-tilt mechanism that is rotatable in a yaw direction and a tilt direction, a yaw direction control unit, a tilt direction control unit, and a slide control unit for focusing, in which the aerial line is imaged in a telephoto manner from the ground over a predetermined length in order to ascertain a damage situation of the aerial line.

JP2000-083246A discloses a master camera that has a distance measurement function using autofocus, is capable of performing distance measurement to a target object, and is capable of measuring a position of the target object in three-dimensional world coordinates from a line-of-sight direction (pan angle and tilt angle) and a measured distance.

JP2002-112421A discloses an aerial line sag monitoring system that includes a camera, known data acquisition means, a coordinate transformation unit, an operation control unit, a screen display unit, and a monitoring and computing unit, in which a calibration process (image correction process) is performed on a still image of a power transmission tower as a measurement target captured by the camera to match a structure diagram of the power transmission tower acquired by the known data acquisition means, and then coordinates of a sag bottom of an aerial line are calculated from the calibrated still image.

### SUMMARY OF THE INVENTION

One embodiment according to the technology of the present disclosure provides an information processing apparatus, a control device, an information processing method, and a computer readable medium storing an information processing program capable of supporting work on a subject.

### 1

An information processing apparatus comprising:
a processor that is communicable with an imaging apparatus and a revolution device causing the imaging apparatus to revolve (i.e., rotate to change orientation),
in which the processor is configured to: acquire first position information based on a revolution condition of the revolution device corresponding to a first subject;
   acquire second position information based on a revolution condition of the revolution device corresponding to a second subject;
   acquire third position information based on a revolution condition of the revolution device corresponding to a third subject; and
   output distance information between the first subject and one of the second subject or the third subject based on the first position information, the second position information, and the third position information.

### 2

The information processing apparatus according to (1),
in which the distance information is distance information between the first subject and a subject, of the second subject and the third subject, closer to the imaging apparatus.

### 3

The information processing apparatus according to (1) or (2),
in which the first subject, the second subject, and the third subject are present on a first surface.

### 4

The information processing apparatus according to any one of (1) to (3),
in which the processor is configured to:
   acquire the first position information based on the revolution condition of the revolution device corresponding to the first subject and an imaging condition of the imaging apparatus;
   acquire the second position information based on the revolution condition of the revolution device corresponding to the second subject and an imaging condition of the imaging apparatus; and
   acquire the third position information based on the revolution condition of the revolution device corresponding to the third subject and an imaging condition of the imaging apparatus.

### 5

The information processing apparatus according to any one of (1) to (3),
in which the second subject is a subject closer to the imaging apparatus than the third subject, and
the processor is configured to:
   acquire the second position information based on the revolution condition of the revolution device corresponding to the second subject and an imaging condition of the imaging apparatus; and
   acquire the third position information based on the revolution condition of the revolution device corresponding to the second subject and the imaging condition of the imaging apparatus, and the revolution condition of the revolution device corresponding to the third subject.

### 6

The information processing apparatus according to any one of (1) to (3),
in which the second subject is a subject closer to the imaging apparatus than the third subject, and
the processor is configured to:
   acquire the second position information based on the revolution condition of the revolution device corresponding to the second subject and an imaging condition of the imaging apparatus; and
   acquire the third position information based on the second position information, a distance between the second subject and the third subject, and the revolution condition of the revolution device corresponding to the third subject.

### 7

The information processing apparatus according to (5) or (6),
in which the first subject, the second subject, and the third subject are present on a first surface, and
the processor is configured to acquire the first position information based on the second position information, the third position information, and the revolution condition of the revolution device corresponding to the first subject.

### 8

The information processing apparatus according to any one of (5) to (7),
in which the processor is configured to specify that the second subject is closer to the imaging apparatus than the third subject based on an imaging condition of the imaging apparatus corresponding to the second subject and an imaging condition of the imaging apparatus corresponding to the third subject.

### 9

The information processing apparatus according to any one of (5) to (8),
in which the processor is configured to acquire the third position information based on information indicating a relative height relationship between the second subject and the third subject.

### 10

The information processing apparatus according to any one of (1) to (9),
in which the revolution condition of the revolution device includes at least one of a pan state or a tilt state of the revolution device.

### 11

The information processing apparatus according to any one of (1) to (10),
in which an imaging condition of the imaging apparatus includes focus information of the imaging apparatus.

### 12

A control device that controls the imaging apparatus and/or the revolution device based on information generated by the information processing apparatus according to any one of (1) to (11).

### 13

An information processing method by an information processing apparatus including a processor that is communicable with an imaging apparatus and a revolution device causing the imaging apparatus to revolve, the method comprising:
via the processor,
acquiring first position information based on a revolution condition of the revolution device corresponding to a first subject;
acquiring second position information based on a revolution condition of the revolution device corresponding to a second subject;
acquiring third position information based on a revolution condition of the revolution device corresponding to a third subject; and
outputting distance information between the first subject and one of the second subject or the third subject based on the first position information, the second position information, and the third position information.

### 14

A computer readable medium storing an information processing program by an information processing apparatus including a processor that is communicable with an imaging apparatus and a revolution device causing the imaging apparatus to revolve, the program causing the processor to execute a process comprising:
acquiring first position information based on a revolution condition of the revolution device corresponding to a first subject;
acquiring second position information based on a revolution condition of the revolution device corresponding to a second subject;
acquiring third position information based on a revolution condition of the revolution device corresponding to a third subject; and
outputting distance information between the first subject and one of the second subject or the third subject based on the first position information, the second position information, and the third position information.

According to the present invention, it is possible to provide an information processing apparatus, a control device, an information processing method, and a computer readable medium an information processing program capable of supporting work on a subject.

### BRIEF DESCRIPTION OF THE DRAWINGS

FIG. 1 is a diagram showing an example of an imaging system 1 equipped with a control device of the present embodiment.

FIG. 2 is a block diagram showing an example of a configuration of an electrical system of a revolution device 16 and a personal computer 11.

FIG. 3 is a block diagram showing an example of a configuration of an optical system and an electrical system of an imaging apparatus 10.

FIG. 4 is a schematic diagram showing an example of maintenance work on a power transmission line.

FIG. 5 is a flowchart showing an example of processing by a CPU 60A of an information processing apparatus 60.

FIG. 6 is a diagram showing an example of distance information displayed on a display 13a of the personal computer 11.

FIG. 7 is a diagram showing a modification example of the distance information displayed on the display 13a of the personal computer 11.

FIG. 8 is a diagram for describing an error that occurs in a case where a distance from the imaging apparatus to a power transmission tower is calculated based on focus information.

FIG. 9 is a flowchart showing a first modification example of the processing by the CPU 60A of the information processing apparatus 60.

FIG. 10 is a diagram for describing calculation of spatial coordinates of a long-range reference position in the first modification example of FIG. 9.

FIG. 11 is a flowchart showing a second modification example of the processing by the CPU 60A of the information processing apparatus 60.

FIG. 12 is a diagram for describing calculation of spatial coordinates of a long-range reference position in the second modification example of FIG. 11.

FIG. 13 is a diagram showing an example of an aspect in which an information processing program is installed in the information processing apparatus 60 of the personal computer 11 from a storage medium in which the information processing program for imaging control is stored.

### DESCRIPTION OF THE PREFERRED EMBODIMENTS

Hereinafter, an example of an embodiment of the present invention will be described with reference to the drawings.

### Imaging System of Embodiment

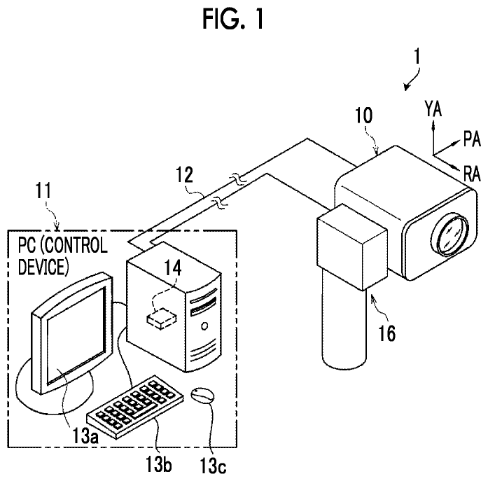

FIG. 1 is a diagram showing an example of an imaging system 1 equipped with a control device of the present embodiment. As shown in FIG. 1, the imaging system 1 includes an imaging apparatus 10, a personal computer (PC) 11, and a revolution device 16. The personal computer (PC) 11 is an example of a “control device” in the present invention.

The imaging apparatus 10 is installed on a column, a wall, or a part (for example, a rooftop) of a building indoors or outdoors via the revolution device 16, and images an imaging target that is a subject. The imaging apparatus 10 is, for example, a camera capable of imaging in a telephoto manner. The imaging apparatus 10 transmits a captured image obtained by imaging and information on the imaging to the personal computer 11 via a communication line 12.

The personal computer 11 comprises a display 13a, a keyboard 13b, a mouse 13c, and a secondary storage device 14. Examples of the display 13a include a liquid crystal display, a plasma display, and an organic electro-luminescence (EL) display.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The personal computer 11 receives the captured image or the information on the imaging transmitted from the imaging apparatus 10, and displays the received captured image or the information on the imaging on the display 13a or stores the received captured image or the information on the imaging in the secondary storage device 14.

For example, the personal computer 11 performs imaging control by communicating with the imaging apparatus 10 via the communication line 12. The imaging control is control of setting an imaging parameter for the imaging apparatus 10 to perform imaging in the imaging apparatus 10 and causing the imaging apparatus 10 to execute imaging. The imaging parameter includes a parameter related to exposure, a parameter related to a size (focal length) of an imaging range, and the like.

In addition, the personal computer 11 performs revolution control by communicating with the revolution device 16 via the communication line 12. The revolution control is control of setting a revolution parameter for the revolution device 16 to perform revolution of the imaging apparatus 10 in the revolution device 16 and causing the revolution device 16 to execute revolution of the imaging apparatus 10. The revolution parameter includes a parameter related to a direction (pan/tilt) of the imaging range of the imaging apparatus 10.

The personal computer 11 sets a revolution direction, a revolution amount, a revolution speed, and the like of the imaging apparatus 10 in response to, for example, an operation of the keyboard 13b or the mouse 13c, or a screen touch operation of the display 13a.

### Configuration of Electrical System of Revolution Device 16 and Personal Computer 11

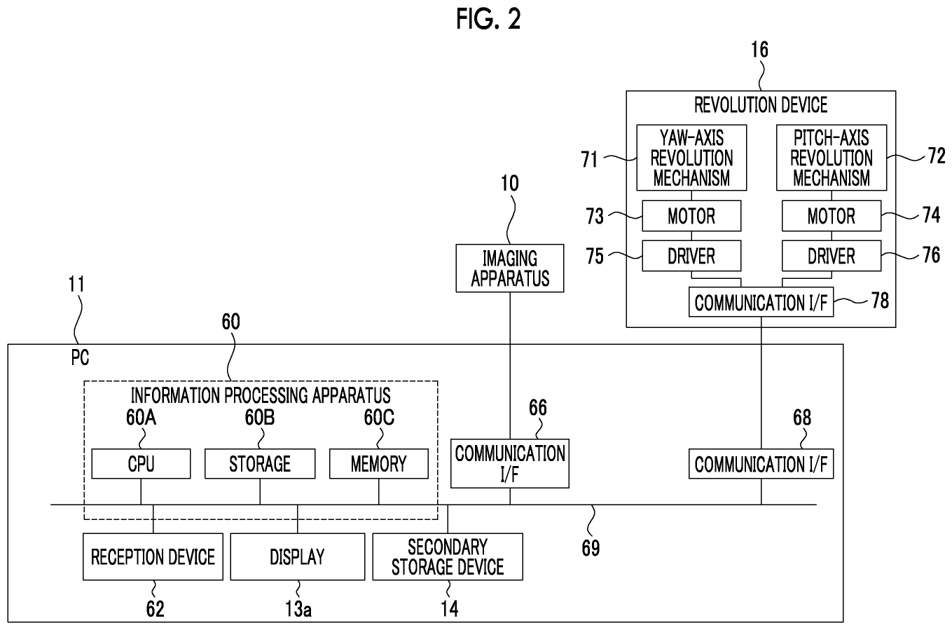

FIG. 2 is a block diagram showing an example of a configuration of an electrical system of the revolution device 16 and the personal computer 11. As shown in FIG. 2, the revolution device 16 comprises a yaw-axis revolution mechanism 71, a pitch-axis revolution mechanism 72, motors 73 and 74, drivers 75 and 76, and a communication I/F 78.

The yaw-axis revolution mechanism 71 causes the revolution device 16 to which the imaging apparatus 10 is attached to revolve (i.e., rotate to change orientation) in a yaw direction. The motor 73 is driven to generate the power under the control of the driver 75. The yaw-axis revolution mechanism 71 receives the power generated by the motor 73 to cause the revolution device 16 to which the imaging apparatus 10 is attached to revolve in the yaw direction. The pitch-axis revolution mechanism 72 causes the revolution device 16 to which the imaging apparatus 10 is attached to revolve in a pitch direction. The motor 74 is driven to generate the power under the control of the driver 76. The pitch-axis revolution mechanism 72 receives the power generated by the motor 74 to cause the revolution device 16 to which the imaging apparatus 10 is attached to revolve in the pitch direction.

The communication I/F 78 is, for example, a network interface. The communication I/F 78 performs transmission control of various types of information to and from the personal computer 11. The network is, for example, a wide area network (WAN) or a local area network (LAN), such as the Internet. The communication I/F 78 performs communication between the revolution device 16 and the personal computer 11.

The personal computer 11 comprises the display 13a, the secondary storage device 14, the information processing apparatus 60, the reception device 62, and the communication I/Fs 66 and 68. The information processing apparatus 60 comprises a CPU 60A, a storage 60B, and a memory 60C.

Each of the reception device 62, the display 13a, the secondary storage device 14, the CPU 60A, the storage 60B, the memory 60C, and the communication I/Fs 66 and 68 is connected to a bus 69. In the example shown in FIG. 2, one bus is shown as the bus 69 for convenience of illustration, but a plurality of buses may be used. The bus 69 may be a serial bus, or may be a parallel bus including a data bus, an address bus, a control bus, and the like.

The memory 60C temporarily stores various types of information and is used as the work memory. Examples of the memory 60C include a RAM, but the technology of the present disclosure is not limited thereto, and another type of storage device may be used. The storage 60B stores various programs for the personal computer 11 (hereinafter, simply referred to as “personal computer program”).

The CPU 60A reads out the personal computer program from the storage 60B and executes the read-out personal computer program on the memory 60C to control the entire personal computer 11. The personal computer program includes an “information processing program” in the present invention. The CPU 60A is an example of a “processor” in the present invention.

The communication I/F 66 is, for example, a network interface. The communication I/F 66 is connected to a communication I/F (not shown) of the imaging apparatus 10 in a communicable manner and performs transmission control of various types of information to and from the imaging apparatus 10. The communication I/F 68 is, for example, a network interface. The communication I/F 68 is connected to a communication I/F 78 of the revolution device 16 in a communicable manner and performs transmission control of various types of information to and from the yaw-axis revolution mechanism 71 and the pitch-axis revolution mechanism 72.

The CPU 60A receives the captured image, information related to the imaging, and the like from the imaging apparatus 10 via the communication I/F 66. In addition, the CPU 60A controls the revolution operation of the yaw-axis revolution mechanism 71 by controlling the driver 75 and the motor 73 of the revolution device 16 via the communication I/F 68 and the communication I/F 78, and controls the revolution operation of the pitch-axis revolution mechanism 72 by controlling the driver 76 and the motor 74 of the revolution device 16.

The reception device 62 is, for example, the keyboard 13b, the mouse 13c, and a touch panel of the display 13a, and receives various instructions from the user. The CPU 60A acquires various instructions received by the reception device 62 and operates in accordance with the acquired instructions. For example, in a case where the reception device 62 receives the processing content for the imaging apparatus 10 or the revolution device 16, the CPU 60A operates the imaging apparatus 10 or the revolution device 16 in accordance with the instruction content received by the reception device 62.

The display 13a displays various types of information under the control of the CPU 60A. Examples of the various types of information displayed on the display 13a include the content of the various instructions received by the reception device 62 and the captured image of the subject or the information related to the imaging received by the communication I/F 66. The CPU 60A displays the content of the various instructions received by the reception device 62 and the captured image of the subject or the information related to the imaging received by the communication I/F 66 on the display 13a.

The secondary storage device 14 is, for example, a non-volatile memory and stores various types of information under the control of the CPU 60A. Examples of the various types of information stored in the secondary storage device 14 include the captured image of the subject or the information related to the imaging received by the communication I/F 66. The CPU 60A stores the captured image of the subject or the information related to the imaging received by the communication I/F 66 in the secondary storage device 14.

### Configuration of Optical System and Electrical System of Imaging Apparatus 10

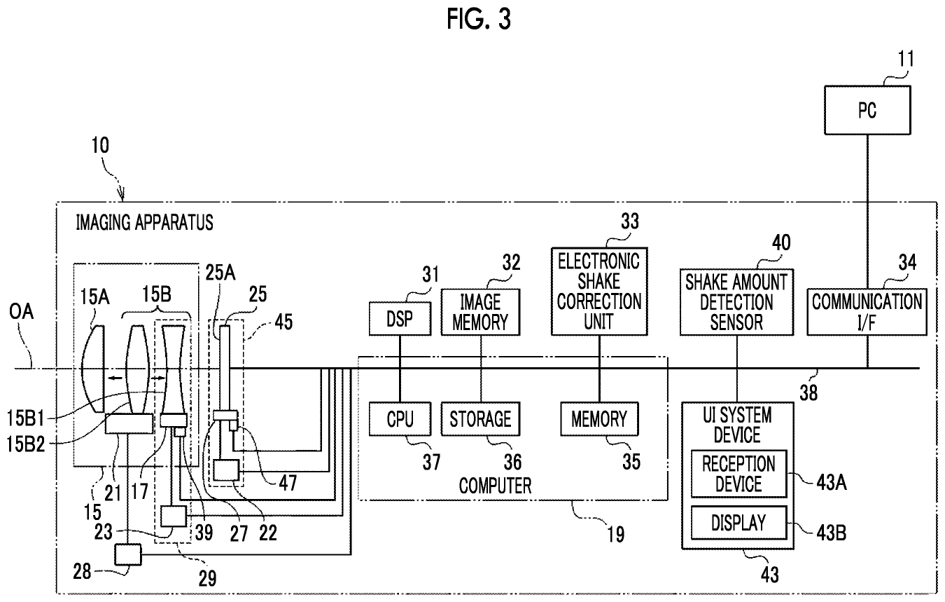

FIG. 3 is a block diagram showing an example of a configuration of an optical system and an electrical system of the imaging apparatus 10. As shown in FIG. 3, the imaging apparatus 10 comprises an optical system 15 and an imaging element 25. The imaging element 25 is positioned at a rear stage of the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not shown), a zoom lens 15B2, and the like. The zoom lens 15B2 is movably supported along the optical axis OA by a lens actuator 21 described later. The anti-vibration lens 15B1 is movably supported in a direction orthogonal to the optical axis OA by a lens actuator 17 described later.

Since the imaging apparatus 10 is on a telephoto side by increasing a focal length with the zoom lens 15B2, an angle of view is reduced (imaging range is narrowed). Since the imaging apparatus 10 is on a wide angle side by reducing the focal length with the zoom lens 15B2, the angle of view is increased (imaging range is widened).

Various lenses (not shown) may be provided as the optical system 15 in addition to the objective lens 15A and the lens group 15B. Furthermore, the optical system 15 may comprise a stop. Positions of the lenses, the lens group, and the stop included in the optical system 15 are not limited, and for example, the technology of the present disclosure is also effective for positions different from positions shown in FIG. 3.

The anti-vibration lens 15B1 is movable in a direction perpendicular to the optical axis OA, and the zoom lens 15B2 is movable along the optical axis OA.

The optical system 15 comprises lens actuators 17 and 21. The lens actuator 17 causes force that fluctuates in a direction perpendicular to an optical axis of the anti-vibration lens 15B1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force for moving along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. The focal length of the imaging apparatus 10 changes as the position of the zoom lens 15B2 moves along the optical axis OA.

In a case where the contour of the captured image is a rectangle having a short side in a direction of a pitch axis PA (refer to FIG. 1) and a long side in a direction of a yaw axis YA (refer to FIG. 1), for example, the angle of view in the direction of the pitch axis PA is narrower than the angle of view in the direction of the yaw axis YA and is narrower than the angle of view of a diagonal line.

With the optical system 15 configured in such a manner, light indicating an imaging region forms an image on the light-receiving surface 25A of the imaging element 25, and the imaging region is imaged by the imaging element 25.

By the way, a vibration applied to the imaging apparatus 10 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Therefore, in the imaging apparatus 10, the shake occurs due to the vibration applied to the imaging apparatus 10 (hereinafter, also simply referred to as “vibration”).

In the present embodiment, the “shake” refers to a phenomenon in which the target subject image on the light-receiving surface 25A of the imaging element 25 in the imaging apparatus 10 fluctuates due to a change in a positional relationship between the optical axis OA and the light-receiving surface 25A. In other words, the “shake” can also be said to be a phenomenon in which the optical image obtained by forming the image on the light-receiving surface 25A fluctuates due to the inclination of the optical axis OA caused by the vibration applied to the imaging apparatus 10. The fluctuation of the optical axis OA means that the optical axis OA is tilted with respect to, for example, a reference axis (for example, the optical axis OA before the shake occurs). Hereinafter, the shake that occurs due to the vibration will be simply referred to as “shake”.

The shake is included in the captured image as a noise component and affects image quality of the captured image. In order to remove the noise component included in the captured image due to the shake, the imaging apparatus 10 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, the power generated by the driving source such as the motor (for example, voice coil motor) to move the imaging element 25 in the direction perpendicular to the optical axis of the imaging optical system. The electronic shake correction unit 33 performs image processing on the captured image based on a shake amount to correct the shake. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 3 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the method of correcting the shake, a shake correction method is employed in which the anti-vibration lens 15B1 is caused to move based on the shake amount detected by a shake amount detection sensor 40 (described later). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed, but the technology of the present disclosure is not limited thereto. Instead of the voice coil motor, another power source such as a stepping motor or a piezoelectric element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39, but the technology of the present disclosure is not limited thereto. Instead of the Hall element, a magnetic sensor, a photo sensor, or the like may be employed.

The lens-side shake correction mechanism 29 causes the anti-vibration lens 15B1 to move along at least one of the direction of the pitch axis PA or the direction of the yaw axis YA in an actually imaged range to correct the shake. That is, the lens-side shake correction mechanism 29 corrects the shake by causing the anti-vibration lens 15B1 to move in the anti-vibration lens two-dimensional plane by a movement amount corresponding to the shake amount.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the method of correcting the shake, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed, but the technology of the present disclosure is not limited thereto. Instead of the voice coil motor, another power source such as a stepping motor or a piezoelectric element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA.

The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47, but the technology of the present disclosure is not limited thereto. Instead of the Hall element, a magnetic sensor, a photo sensor, or the like may be employed.

The imaging apparatus 10 comprises a computer 19, a digital signal processor (DSP) 31, an image memory 32, an electronic shake correction unit 33, a communication I/F 34, a shake amount detection sensor 40, and a user interface (UI) system device 43. The computer 19 comprises a memory 35, a storage 36, and a central processing unit (CPU) 37. The imaging apparatus 10 detects a specific subject using a machine learning model via a processor in the computer 19. For example, the processor may be the CPU 37 or may be another processor.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 3, one bus is shown as the bus 38 for convenience of illustration, but a plurality of buses may be used. The bus 38 may be a serial bus, or may be a parallel bus including a data bus, an address bus, a control bus, and the like.

The memory 35 temporarily stores various types of information, and is used as a work memory. Examples of the memory 35 include a random access memory (RAM), but the technology of the present disclosure is not limited thereto, and another type of storage device may be used. The storage 36 stores various programs for the imaging apparatus 10. The CPU 37 reads out various programs from the storage 36 and executes the read-out various programs on the memory 35 to control the entire imaging apparatus 10. An example of the storage 36 includes a flash memory, SSD, EEPROM, or HDD. Further, for example, various non-volatile memories such as a magnetoresistive memory and a ferroelectric memory may be used instead of the flash memory or together with the flash memory.

The imaging element 25 is a complementary metal oxide semiconductor (CMOS) image sensor. The imaging element 25 images a target subject at a predetermined frame rate under an instruction of the CPU 37. The term “predetermined frame rate” described herein refers to, for example, several tens of frames per second to several hundreds of frames per second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not shown) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, the photoelectric conversion element having sensitivity to R (red) light (for example, photoelectric conversion element in which an R filter corresponding to R is disposed), the photoelectric conversion element having sensitivity to G (green) light (for example, photoelectric conversion element in which a G filter corresponding to G is disposed), and the photoelectric conversion element having sensitivity to B (blue) light (for example, photoelectric conversion element in which a B filter corresponding to B is disposed) are employed as the plurality of photoelectric conversion elements. In the imaging apparatus 10, imaging based on visible light (for example, light on a short wavelength side of about 700 nanometers or less) is performed by using these photosensitive pixels. However, the present embodiment is not limited thereto, and the imaging based on infrared light (for example, light on a wavelength side longer than about 700 nanometers) may be performed. In this case, a plurality of photoelectric conversion elements having sensitivity to the infrared light may be used as the plurality of photosensitive pixels. In particular, for imaging of short-wavelength infrared (SWIR), for example, an InGaAs sensor and/or a simulation of type-II quantum well (T2SL) sensor may be used.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is described as an example of the imaging element 25, but the technology of the present disclosure is not limited thereto. A charge coupled device (CCD) image sensor may be employed as the imaging element 25. In this case, the imaging element 25 is connected to the bus 38 via an analog front end (AFE) (not shown) that incorporates a CCD driver. The AFE performs the signal processing, such as the A/D conversion, on the analog imaging signal obtained by the imaging element 25 to generate the digital image and output the generated digital image to the DSP 31. The CCD image sensor is driven by the CCD driver incorporated in the AFE. As a matter of course, the CCD driver may be independently provided.

The DSP 31 performs various types of digital signal processing on the digital image. For example, the various types of digital signal processing refer to demosaicing, noise removal processing, gradation correction processing, and color correction processing. The DSP 31 outputs a digital image after digital signal processing to the image memory 32 for each frame. The image memory 32 stores a digital image from the DSP 31.

The shake amount detection sensor 40 is a device including, for example, a gyro sensor, and detects the shake amount of the imaging apparatus 10. In other words, the shake amount detection sensor 40 detects the shake amount in each of a pair of axial directions. The gyro sensor detects a rotational shake amount around respective axes (refer to FIG. 1) of the pitch axis PA, the yaw axis YA, and a roll axis RA (axis parallel to the optical axis OA). The shake amount detection sensor 40 converts the rotational shake amount around the pitch axis PA and the rotational shake amount around the yaw axis YA, which are detected by the gyro sensor, into the shake amount in a two-dimensional plane parallel to the pitch axis PA and the yaw axis YA to detect the shake amount of the imaging apparatus 10.

Here, the gyro sensor is described as an example of the shake amount detection sensor 40, but this is merely an example. The shake amount detection sensor 40 may be an acceleration sensor. The acceleration sensor detects the shake amount in the two-dimensional plane parallel to the pitch axis PA and the yaw axis YA. The shake amount detection sensor 40 outputs the detected shake amount to the CPU 37.

Further, although the form example is shown in which the shake amount is detected by a physical sensor called the shake amount detection sensor 40, the technology of the present disclosure is not limited thereto. For example, a movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 performs the image processing on the captured image in the image memory 32 based on the shake amount detected by the shake amount detection sensor 40 to correct the shake.

Here, the device including the ASIC is exemplified as the electronic shake correction unit 33, but the technology of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and performs transmission control of various types of information to and from the personal computer 11 via the network. The network is, for example, a WAN or a LAN. The communication I/F 34 performs communication between the imaging apparatus 10 and the personal computer 11.

The UI system device 43 comprises a reception device 43A and a display 43B. The reception device 43A is, for example, a hard key, a touch panel, or the like, and receives various instructions from the user. The CPU 37 acquires various instructions received by the reception device 43A and operates in accordance with the acquired instructions.

The display 43B displays various types of information under the control of the CPU 37. Examples of the various types of information displayed on the display 43B include a content of various instructions received by the reception device 43A and the captured image.

### Maintenance Work Example of Defective Location

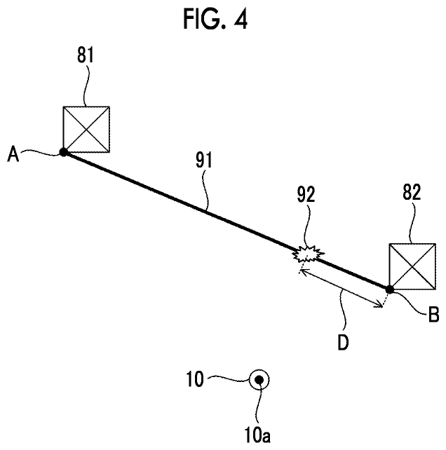

FIG. 4 is a schematic diagram showing an example of maintenance work on a power transmission line. As shown in FIG. 4, for example, a power transmission line 91 connected between a power transmission tower 81 and a power transmission tower 82 may be inspected using a camera (imaging apparatus 10). In this case, for example, the power transmission line 91 is imaged using a camera capable of imaging at a long distance, and the presence or absence of a defective location is checked. In addition, in a case where the defective location checked during the inspection is maintained on a subsequent day, for example, a worker may go to the site, image the power transmission line 91 using the camera in the same manner as during the inspection, and perform maintenance work on the defective location 92. In this case, it is desirable to be able to quickly and accurately ascertain the position of the defective location on the power transmission line 91. The present invention makes it possible to appropriately provide a user with information on a detection position of a defective location detected in a subject such as the power transmission line 91.

Specifically, during the inspection of the power transmission line 91, an image of the power transmission line 91 is captured by a camera installed at an imaging apparatus position 10a in FIG. 4. The captured image of the power transmission line 91 is configured as, for example, an image in which a plurality of divided captured images obtained by dividing a range from an end part A of the power transmission line 91 connected to the power transmission tower 81 to an end part B of the power transmission line 91 connected to the power transmission tower 82 according to the size (focal length) of the imaging range of the camera and sequentially imaging the divided ranges are continuously connected.

In a case where the inspection work of the divided captured image is performed together with the imaging of the power transmission line 91 and the defective location 92 is detected in the power transmission line 91, revolution information and imaging information related to the defective location 92 are stored. The revolution information is a pan value and a tilt value of the camera associated with the divided captured image including the detected defective location 92. The revolution information is the revolution information of the camera at a point in time at which the defective location 92 is imaged. The revolution information is an example of a “revolution condition” in the present invention. The pan value and the tilt value of the camera are the same as, for example, the pan value and the tilt value of the revolution device 16 to which the camera is attached. The imaging information is focus information of the camera associated with the divided captured image including the detected defective location 92. The focus information is information capable of calculating a distance from the camera to the divided captured image. The imaging information is imaging information of the camera at a point in time at which the defective location 92 is imaged. The imaging information is an example of an “imaging condition” in the present invention.

Similarly, the revolution information and the imaging information related to the end part A of the power transmission line 91 connected to the power transmission tower 81, and the revolution information and the imaging information related to the end part B of the power transmission line 91 connected to the power transmission tower 82 are stored. The revolution information of the end part A is a pan value and a tilt value of the camera associated with the divided captured image including the end part A of the power transmission line 91. The imaging information of the end part A is focus information of the camera associated with the divided captured image including the end part A. In addition, the revolution information of the end part B is a pan value and a tilt value of the camera associated with the divided captured image including the end part B of the power transmission line 91. The imaging information of the end part B is focus information of the camera associated with the divided captured image including the end part B. The revolution information of the defective location 92 and the revolution information of the end part A and the end part B of the power transmission line 91 can be measured with reference to the revolution information in a case where the revolution amount of the camera is 0 (zero).

In the present invention, based on the revolution information and the imaging information, the position information of the defective location 92 can be provided to the user as a distance from the power transmission tower to the defective location 92, for example, a distance D (FIG. 4) from the end part B of the power transmission line 91 in the power transmission tower 82 to the defective location 92.

### Processing by CPU 60A of Information Processing Apparatus 60

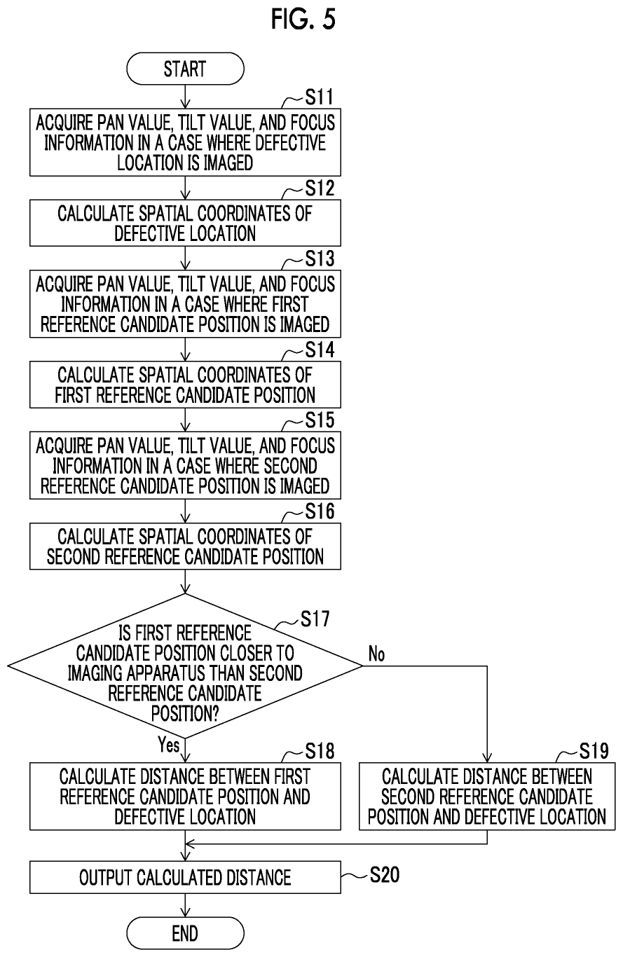

FIG. 5 is a flowchart showing an example of processing by the CPU 60A of the information processing apparatus 60. In starting the present processing, the user displays, for example, a captured image of the power transmission line on which maintenance work is performed, on the display 13a of the personal computer 11. As described in FIG. 4, the captured image of the power transmission line is, for example, an image composed of a plurality of divided captured images obtained by dividing the power transmission line 91 connected between the power transmission tower 81 and the power transmission tower 82 according to the size (focal length) of the imaging range of the camera. The user determines the defective location of the power transmission line, the first reference candidate position, and the second reference candidate position, which are the reference points of the power transmission line, in the captured image of the power transmission line displayed on the display 13a. The user can determine the defective location, the first reference candidate position, and the second reference candidate position by selecting the divided captured image including the defective location, the first reference candidate position, and the second reference candidate position from the captured image of the power transmission line. The divided captured image may be selected, for example, by the user performing a touch operation on the defective location, the first reference candidate position, and the second reference candidate position on the display 13a, or may be selected by recognizing the divided captured image and selecting the divided captured image by artificial intelligence (AI) detection. In addition, the first reference candidate position and the second reference candidate position may be selected as the first and last divided captured images in the plurality of divided captured images. In a case where the defective location, the first reference candidate position, and the second reference candidate position in the power transmission line are selected, the CPU 60A of the information processing apparatus 60 starts the processing shown in FIG. 5.

The defective location is an example of a “first subject” in the present invention, and is, for example, a defective location 92 shown in FIG. 4. The first reference candidate position is an example of a “second subject” in the present invention, and is, for example, a power transmission line holding portion of the power transmission tower 82 to which the end part B of the power transmission line 91 shown in FIG. 4 is connected. The second reference candidate position is an example of a “third subject” in the present invention, and is, for example, a power transmission line holding portion of the power transmission tower 81 to which the end part A of the power transmission line 91 shown in FIG. 4 is connected.

First, the CPU 60A acquires the pan value, the tilt value, and the focus information in a case where the defective location is imaged from the secondary storage device 14 (step S11). The pan value, the tilt value, and the focus information are the pan value, the tilt value, and the focus information of the camera associated with the divided captured image including the defective location.

Next, the CPU 60A calculates the spatial coordinates of the defective location based on the pan value, the tilt value, and the focus information acquired in step S11 (step S12). The spatial coordinates are an example of “position information” in the present invention. The spatial coordinates are coordinates indicating a position in a real space, and are, for example, geographic coordinates consisting of a latitude, a longitude, and a height. The spatial coordinates of the defective location can be calculated as coordinates obtained by moving, by a focal length obtained based on the focus information of the camera, in an imaging direction specified by the pan value and the tilt value of the camera associated with the divided captured image including the defective location, from the spatial coordinates indicating the installation position of the camera, with the pan value and the tilt value in a case where the revolution amount of the camera is 0 (zero) as a reference imaging direction.

Next, the CPU 60A acquires the pan value, the tilt value, and the focus information in a case where the first reference candidate position is imaged from the secondary storage device 14 (step S13). The pan value, the tilt value, and the focus information are the pan value, the tilt value, and the focus information of the camera associated with the divided captured image including the first reference candidate position.

Next, the CPU 60A calculates the spatial coordinates of the first reference candidate position based on the pan value, the tilt value, and the focus information acquired in step S13 (step S14). The spatial coordinates of the first reference candidate position can also be calculated in the same manner as the spatial coordinates of the defective location.

Next, the CPU 60A acquires the pan value, the tilt value, and the focus information in a case where the second reference candidate position is imaged from the secondary storage device 14 (step S15). The pan value, the tilt value, and the focus information are the pan value, the tilt value, and the focus information of the camera associated with the divided captured image including the second reference candidate position.

Next, the CPU 60A calculates the spatial coordinates of the second reference candidate position based on the pan value, the tilt value, and the focus information acquired in step S15 (step S16). The spatial coordinates of the second reference candidate position can also be calculated in the same manner as the spatial coordinates of the defective location.

Next, the CPU 60A compares the distance from the camera (imaging apparatus) to the first reference candidate position with the distance from the camera to the second reference candidate position to determine whether or not the first reference candidate position is closer to the camera than the second reference candidate position (step S17). The distance from the camera to the first reference candidate position and the distance from the camera to the second reference candidate position may be determined based on the focus information of the first reference candidate position acquired in step S13 and the focus information of the second reference candidate position acquired in step S15, or may be determined based on the spatial coordinates of the first reference candidate position calculated in step S14 and the spatial coordinates of the second reference candidate position calculated in step S16.

In a case where the first reference candidate position is closer to the camera (step S17: Yes), the CPU 60A calculates the distance between the first reference candidate position and the defective location (step S18). The distance between the first reference candidate position and the defective location is calculated from the spatial coordinates of the first reference candidate position calculated in step S14 and the spatial coordinates of the defective location calculated in step S12.

In a case where the second reference candidate position is closer to the camera (step S17: No), the CPU 60A calculates the distance between the second reference candidate position and the defective location (step S19). The distance between the second reference candidate position and the defective location is calculated from the spatial coordinates of the second reference candidate position calculated in step S16 and the spatial coordinates of the defective location calculated in step S12.

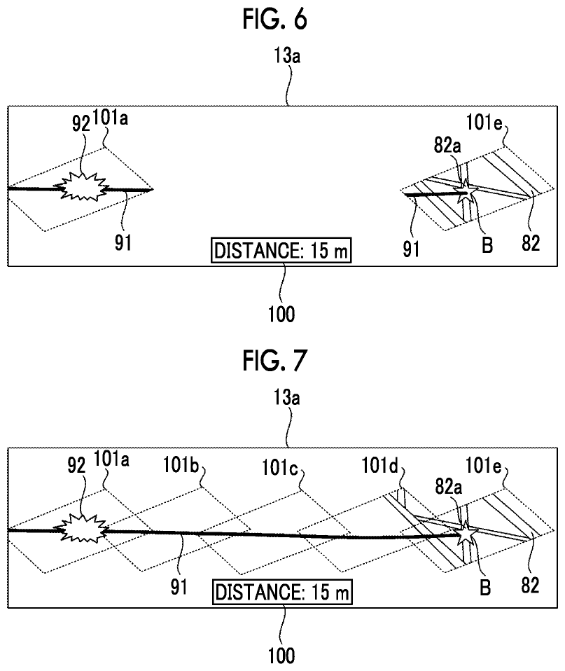

Next, the CPU 60A outputs the distance between the reference candidate position and the defective location calculated in step S18 or step S19 to, for example, the display 13a (step S20). The output to the display 13a will be described later with reference to FIGS. 6 and 7.

In the above-described example, a case where the power transmission line is divided in advance and the pan value, the tilt value, and the focus information are stored in association with each divided captured image has been described, but the present invention is not limited thereto. For example, the user may control the imaging apparatus 10 via the personal computer 11 at the maintenance work site of the power transmission line 91, capture images of three locations of the defective location, the first reference candidate position, and the second reference candidate position, and store the pan value, the tilt value, and the focus information at that time.

### Display Image of Personal Computer 11

FIG. 6 is a diagram showing an example of distance information displayed on the display 13a of the personal computer 11. The personal computer 11 displays, on the display 13a, distance information indicating, for example, the distance between the reference candidate position close to the defective location and the defective location, which is calculated by the CPU 60A of the information processing apparatus 60.

For example, as shown in FIG. 6, the personal computer 11 displays, on the display 13a, distance information 100 indicating a distance between the power transmission line holding portion 82a of the power transmission tower 82 to which the end part B of the power transmission line 91 is connected and the defective location 92 of the power transmission line 91. In the present example, the power transmission line holding portion 82a of the power transmission tower 82 to which the end part B of the power transmission line 91 is connected is the reference candidate position close to the defective location 92. The distance information may be a straight line distance between the two or may be obtained by decomposing the distance between the two into a horizontal direction and a vertical direction. In addition, the personal computer 11 displays, on the display 13a, a divided captured image 101a including the defective location 92 of the power transmission line 91 and a divided captured image 101e including the power transmission line holding portion 82a of the power transmission tower 82 to which the end part B of the power transmission line 91 is connected. The distance information 100 in the present example indicates that the straight line distance between the power transmission line holding portion 82a of the power transmission tower 82 to which the end part B of the power transmission line 91 is connected and the defective location 92 of the power transmission line 91 is 15 m.

FIG. 7 is a diagram showing a modification example of the distance information displayed on the display 13a of the personal computer 11. In the example shown in FIG. 6, only the divided captured image 101a including the defective location 92 of the power transmission line 91 and the divided captured image 101e including the power transmission line holding portion 82a of the power transmission tower 82 to which the end part B of the power transmission line 91 is connected are displayed on the display 13a, but in the present modification example, an image of the power transmission line 91 present between the power transmission line 91 of the divided captured image 101a and the power transmission line 91 of the divided captured image 101e is also displayed on the display 13a. Specifically, as shown in FIG. 7, divided captured images 101b, 101c, and 101d obtained by imaging the power transmission line 91 present between the divided captured image 101a including the defective location 92 and the divided captured image 101e including the power transmission line holding portion 82a of the power transmission tower 82 to which the end part B of the power transmission line 91 is connected are displayed on the display 13a.

As described above, the information processing apparatus 60 of the present embodiment can output the distance information between the reference candidate position and the defective location 92 based on the position information acquired based on the revolution condition (pan/tilt value) of the revolution device 16 and the imaging condition (focus information) of the imaging apparatus 10 for the defective location 92 and the position information acquired based on the revolution condition of the revolution device 16 and the imaging condition of the imaging apparatus 10 for the reference candidate position (power transmission line holding portions of the power transmission towers 81 and 82). Therefore, it is possible to easily specify a position of the defective location 92 of the power transmission line 91 in the real space, and it is possible to smoothly perform the maintenance work of the defective location 92 of the power transmission line 91.

### Error in Case Where Distance Is Calculated from Focus Information

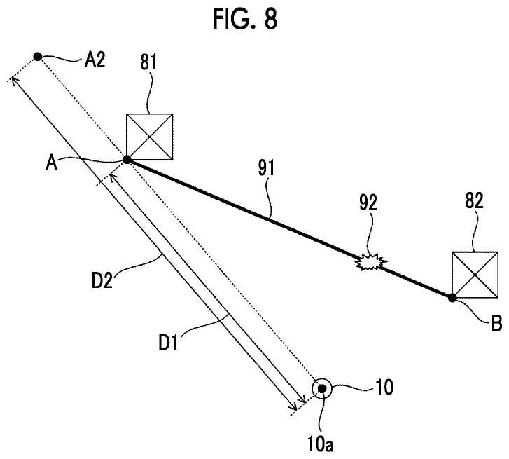

FIG. 8 is a diagram for describing an error that occurs in a case where a distance from the imaging apparatus to the power transmission tower is calculated based on focus information. In a case where a distance from the imaging apparatus to the subject is calculated based on the focus information, in general, the accuracy of the calculated distance is lower as the distance to the subject is longer.

For example, as shown in FIG. 8, in a case where a distance from the imaging apparatus 10 (camera) to the power transmission tower 81 is longer than a distance from the imaging apparatus 10 to the power transmission tower 82, the distance between the imaging apparatus 10 and the power transmission tower calculated based on the focus information has lower calculation accuracy for the distance to the power transmission tower 81, which is farther, than for the distance to the power transmission tower 82, which is closer. Specifically, in a case where a correct distance from the imaging apparatus 10 to the end part A of the power transmission line 91 connected to the power transmission tower 81 is a distance D1, but a distance to the end part A of the power transmission line 91 is calculated based on the focus information acquired by the imaging apparatus 10, a distance D2 longer than the distance D1 may be calculated. In this case, a position of the end part of the power transmission line 91 calculated based on the distance D2 calculated from the focus information is set as a position of the end part A2 farther than the end part A1.

### Modification Example of Processing by CPU 60A

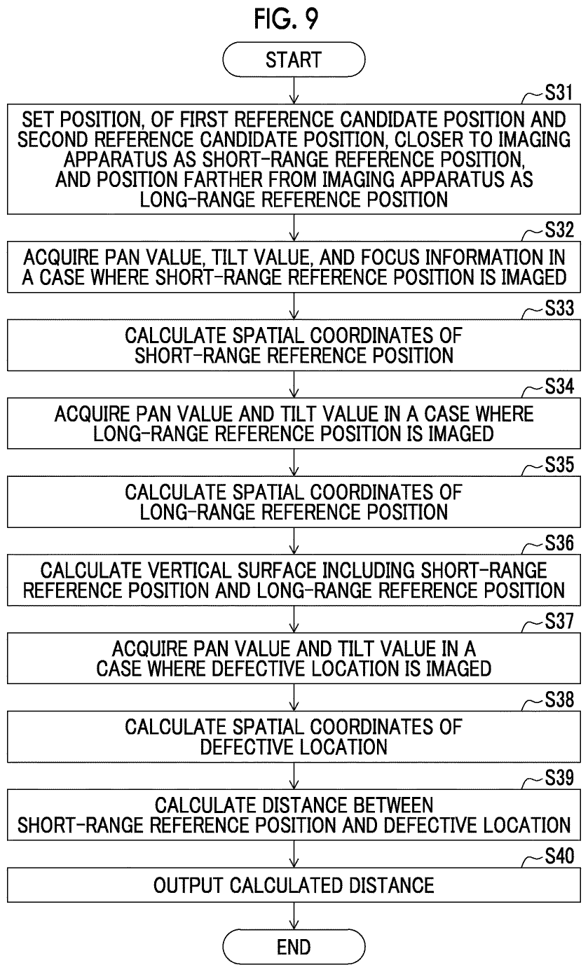

FIG. 9 is a flowchart showing a first modification example of the processing by the CPU 60A of the information processing apparatus 60. In the first modification example, in consideration of the fact that the accuracy of the distance calculated based on the focus information of the subject far from the imaging apparatus 10 (camera) is low, the position information of the subject far from the imaging apparatus 10 is calculated without using the focus information, and the distance information from the defective location of the power transmission line 91 to the reference position is output. An operation performed by the user in a case of starting the present modification processing is the same as the operation content described in FIG. 5.

First, the CPU 60A sets a reference candidate position, of the first reference candidate position and the second reference candidate position, closer to the camera (imaging apparatus 10) as a short-range reference position, and sets a reference candidate position farther from the camera as a long-range reference position (step S31). Which of the first reference candidate position and the second reference candidate position is closer to the camera may be determined by the CPU 60A from the focus information of the camera in a case where the first reference candidate position is imaged and the focus information of the camera in a case where the second reference candidate position is imaged, or may be designated by the user.

Next, the CPU 60A acquires the pan value, the tilt value, and the focus information in a case where the short-range reference position is imaged from the secondary storage device 14 (step S32). The pan value, the tilt value, and the focus information are the pan value, the tilt value, and the focus information of the camera associated with the divided captured image including the short-range reference position. For example, the short-range reference position is a position of the power transmission line holding portion that holds the end part B of the power transmission line 91 in the power transmission tower 82 shown in FIG. 8.

Next, the CPU 60A calculates the spatial coordinates of the short-range reference position based on the pan value, the tilt value, and the focus information acquired in step S32 (step S33). The spatial coordinates of the short-range reference position can be calculated in the same manner as the spatial coordinates of the defective location described in step S12 of FIG. 5.

Next, the CPU 60A acquires the pan value and the tilt value in a case where the long-range reference position is imaged from the secondary storage device 14 (step S34). The pan value and the tilt value are the pan value and the tilt value of the camera associated with the divided captured image including the long-range reference position. For example, the long-range reference position is a position of the power transmission line holding portion that holds the end part A of the power transmission line 91 in the power transmission tower 81 shown in FIG. 8.

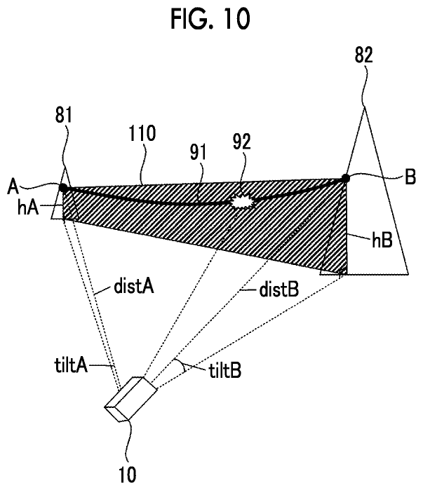

Next, the CPU 60A calculates the spatial coordinates of the long-range reference position based on the pan value and the tilt value related to the long-range reference position acquired in step S34 and the pan value, the tilt value, and the focus information related to the short-range reference position acquired in step S32 (step S35). The calculation of the spatial coordinates of the long-range reference position will be described later with reference to FIG. 10.

Next, the CPU 60A calculates the vertical surface including the short-range reference position calculated in step S33 and the long-range reference position calculated in step S35 (step S36). The defective location, which is a location on the power transmission line 91, is present on the vertical surface including the short-range reference position and the long-range reference position. The vertical surface is a common surface on which the short-range reference position, the long-range reference position, and the defective location are present. The vertical surface is a common plane in which an error is allowed.

Next, the CPU 60A acquires the pan value and the tilt value in a case where the defective location is imaged from the secondary storage device 14 (step S37). The pan value and the tilt value are the pan value and the tilt value of the camera associated with the divided captured image including the defective location. For example, the defective location is the defective location 92 shown in FIG. 8.

Next, the CPU 60A calculates the spatial coordinates of the defective location based on the pan value and the tilt value acquired in step S37 and the vertical surface calculated in step S36 (step S38). The spatial coordinates of the defective location can be calculated by obtaining an intersection of a straight line obtained based on the pan value and the tilt value acquired in step S37 and the vertical surface calculated in step S36.

Next, the CPU 60A calculates a distance between the short-range reference position and the defective location (step S39). The distance between the short-range reference position and the defective location is calculated from the spatial coordinates of the short-range reference position calculated in step S33 and the spatial coordinates of the defective location calculated in step S38.

Next, the CPU 60A outputs the distance between the short-range reference position and the defective location calculated in step S39 to, for example, the display 13a (step S40).

FIG. 10 is a diagram for describing calculation of spatial coordinates of the long-range reference position in the first modification example of FIG. 9. As shown in FIG. 10, the power transmission line 91 is connected between the power transmission tower 81 and the power transmission tower 82. An end part A of the power transmission line 91 is held by the power transmission line holding portion of the power transmission tower 81, and an end part B of the power transmission line 91 is held by the power transmission line holding portion of the power transmission tower 82. The power transmission line holding portion of the power transmission tower 81 to which the end part A of the power transmission line 91 is connected is the long-range reference position, and the power transmission line holding portion of the power transmission tower 82 to which the end part B of the power transmission line 91 is connected is the short-range reference position.

For example, it is assumed that a height hA of the long-range reference position and a height hB of the short-range reference position are the same height (hA=hB=h). In this case, a distance (distA) from the imaging apparatus 10 to the long-range reference position can be obtained by the following expression.
hA=hB
h=distb×sin(tiltB)

distA=h/sin(tiltA) =distB×sin(tiltB)/sin(tiltA)

In addition, for example, it is assumed that the height hA of the long-range reference position and the height hB of the short-range reference position are a predetermined height ratio (hA=hB×r). In this case, a distance (distA) from the imaging apparatus 10 to the long-range reference position can be obtained by the following expression.
hA=hB×r
hB=distB×sin(tiltB)

distA=hA/sin(tiltA) =distB×sin(tiltB)×r/sin(tiltA)

As described above, the distance (distA) from the imaging apparatus 10 to the long-range reference position can be calculated without using the focus information of the long-range reference position. As a result, the spatial coordinates of the long-range reference position can be calculated as coordinates of a point obtained by moving from the spatial coordinates of the imaging apparatus 10 by the distance (distA) of the long-range reference position in the imaging direction specified by the pan value and the tilt value associated with the divided captured image including the long-range reference position. The information (same height, height ratio) indicating the height relationship between the long-range reference position and the short-range reference position can be designated by, for example, an input operation by the user.

In addition, in FIG. 10, the vertical surface 110 indicated by the diagonal line including the end part A and the end part B of the power transmission line 91 is the vertical surface calculated in step S36 of FIG. 9. The short-range reference position, the long-range reference position, and the defective location 92 of the power transmission line 91 are present on the vertical surface 110. Therefore, the intersection between the straight line extending from the spatial coordinates of the imaging apparatus 10 in the imaging direction specified by the pan value and the tilt value associated with the divided captured image including the defective location 92 and the vertical surface 110 can be calculated as the spatial coordinates of the defective location 92. Then, the distance from the short-range reference position to the defective location 92 of the power transmission line 91 can be calculated based on the calculated spatial coordinates.

According to the first modification example of the processing by the CPU 60A as described above, the position information of the long-range reference position can be acquired based on the revolution condition (pan/tilt value) of the revolution device 16 and the imaging condition (focus information) of the imaging apparatus 10 for the short-range reference position and the revolution condition of the revolution device 16 for the long-range reference position. Therefore, in a case where the distance from the imaging apparatus 10 to the long-range reference position is long and the accuracy of the distance information based on the imaging condition of the long-range reference position is low, the distance information of the long-range reference position can be acquired with high accuracy without using the imaging condition of the long-range reference position. In addition, the position information of the defective location 92 can be acquired based on the position information of the short-range reference position, the position information of the long-range reference position, and the revolution condition of the revolution device 16 for the defective location 92. Therefore, in a case where the distance from the imaging apparatus 10 to the defective location 92 is long and the accuracy of the distance information based on the imaging condition of the defective location 92 is low, the distance information of the defective location 92 can be acquired with high accuracy without using the imaging condition of the defective location 92. Accordingly, the distance from the defective location 92 to the short-range reference position can be calculated, and it is possible to easily specify the position of the defective location 92 of the power transmission line 91 in the real space. Therefore, it is possible to smoothly perform the maintenance work on the defective location 92.

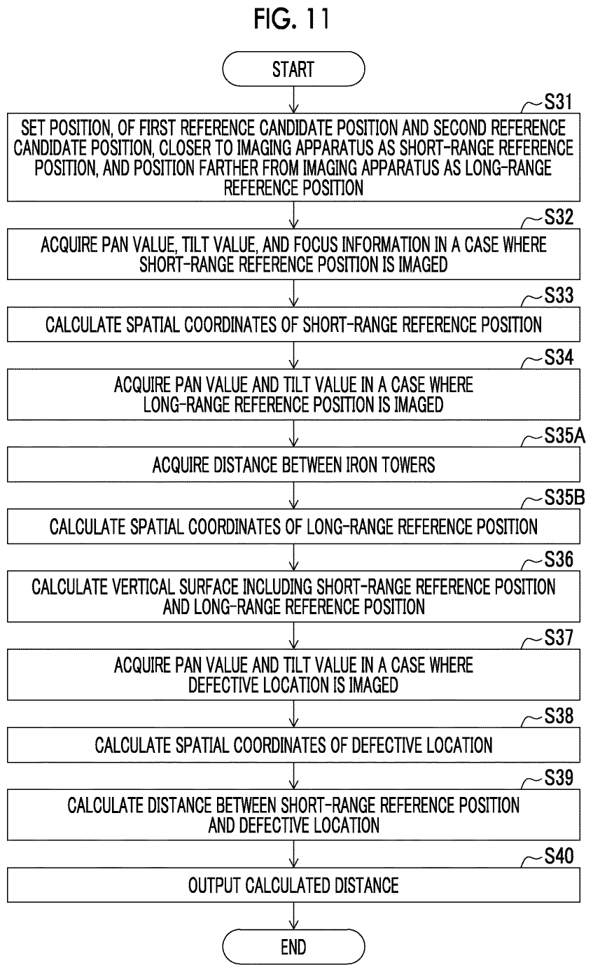

FIG. 11 is a flowchart showing a second modification example of the processing by the CPU 60A of the information processing apparatus 60. The second modification example is different from the first modification example in that the position information of the distant subject is calculated without using the focus information of the distant subject from the imaging apparatus 10 (camera) as in the first modification example, but the distance between the near subject and the distant subject is used to calculate the position information of the distant subject.

As shown in FIG. 11, in the second modification example, the processing from step S31 to step S34 is the same as the processing from step S31 to step S34 in the first modification example described with reference to FIG. 9.

Next, the CPU 60A acquires the distance L between the power transmission tower 81 to which the end part A of the power transmission line 91 is connected and the power transmission tower 82 to which the end part B of the power transmission line 91 is connected (step S35A). The distance between the power transmission tower 81 and the power transmission tower 82 is, for example, a distance input and designated by the user operating the personal computer 11.

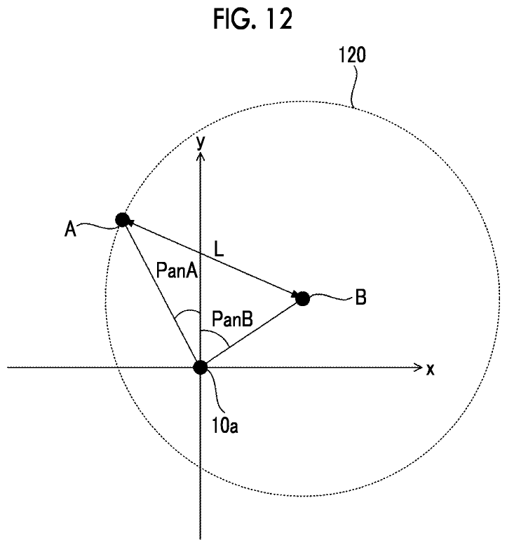

Next, the CPU 60A calculates the spatial coordinates of the long-range reference position based on the distance L between the power transmission tower 81 and the power transmission tower 82 acquired in step S35A and the pan value and the tilt value related to the long-range reference position acquired in step S34 (step S35B). The calculation of the spatial coordinates of the long-range reference position will be described later with reference to FIG. 12.

The processing from step S36 to step S40 is the same as the processing from step S36 to step S40 in the first modification example described with reference to FIG. 9.

FIG. 12 is a diagram for describing the calculation of the spatial coordinates of the long-range reference position in the second modification example of FIG. 11. In FIG. 12, the end part A of the power transmission line 91 held by the power transmission line holding portion of the power transmission tower 81, the end part B of the power transmission line 91 held by the power transmission line holding portion of the power transmission tower 82, and the imaging apparatus position 10a at which the imaging apparatus 10 (camera) is installed are viewed from above. On a horizontal plane represented by the x-axis and the y-axis, an intersection of the x-axis and the y-axis is the imaging apparatus position 10a, and a y-axis direction is a reference imaging direction specified by a pan value in a case where a revolution amount of the camera is 0 (zero). In addition, the distance between the end part A of the power transmission line 91 connected to the power transmission tower 81 and the end part B of the power transmission line 91 connected to the power transmission tower 82 is the distance L between the power transmission towers. The end part B of the power transmission line 91 is the short-range reference position in FIG. 11, and the end part A of the power transmission line 91 is the long-range reference position in FIG. 11.

A distance from the imaging apparatus position 10a to the end part B of the power transmission line 91 on the x-y horizontal plane can be represented by distB×cos(tiltB) (refer to FIG. 10). Therefore, the position of the end part B of the power transmission line 91 is represented by (distB×cos(tiltB)×sin(PanB), distB×cos(tiltB)×cos(PanB)).

Therefore, the position of the end part A of the power transmission line 91 on the x-y horizontal plane can be obtained by drawing a circle 120 having a radius equal to the distance L with the end part B of the power transmission line 91 as a center and calculating an intersection of the circle 120 and the imaging direction of the end part A of the power transmission line 91 specified by PanA. Accordingly, the distance from the imaging apparatus position 10a to the end part A of the power transmission line 91 can be calculated.

As described above, the distance from the imaging apparatus 10 to the long-range reference position can be calculated without using the focus information of the long-range reference position by using the distance L between the power transmission towers. Accordingly, the spatial coordinates of the long-range reference position can be calculated as coordinates of a point moved by the height hA of the long-range reference position in the vertical direction from the position of the end part A of the power transmission line 91 on the x-y horizontal plane.

According to the second modification example of the processing by the CPU 60A as described above, the position information of the long-range reference position can be acquired based on the position information acquired based on the revolution condition (pan/tilt value) of the revolution device 16 and the imaging condition (focus information) of the imaging apparatus 10 with respect to the short-range reference position, the distance L between the short-range reference position and the long-range reference position, and the revolution condition of the revolution device 16 with respect to the long-range reference position. Therefore, as in the first modification example, even in a case where the distance from the imaging apparatus 10 to the long-range reference position is long, the distance information of the long-range reference position can be acquired with high accuracy. In addition, even in a case where the distance from the imaging apparatus 10 to the defective location 92 is long, the distance information of the defective location 92 can be acquired with high accuracy. Accordingly, it is possible to easily specify a position of the defective location 92 of the power transmission line 91 in the real space, and it is possible to smoothly perform the maintenance work of the defective location 92.

In the above-described form, a case where the defective location is present in the power transmission line has been described, but the present invention is not limited thereto. The defective location may be, for example, present on a wall surface of a building. That is, the present invention can be applied even in a case where the wall surface of the building is inspected and maintained.

### Storage Medium of Information Processing Program

In each imaging control described above, an example has been described in which the information processing program of each embodiment is stored in the storage 60B of the information processing apparatus 60 and the CPU 60A of the information processing apparatus 60 executes the information processing program in the memory 60C, but the technology of the present disclosure is not limited thereto.

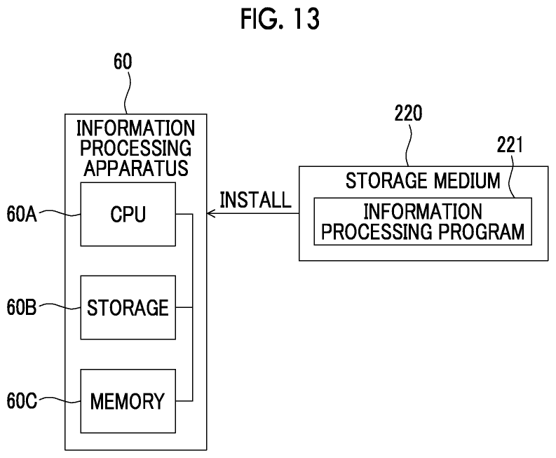

FIG. 13 is a diagram showing an example of an aspect in which the information processing program is installed in the information processing apparatus 60 of the personal computer 11 from a storage medium in which the information processing program for imaging control is stored. As shown in FIG. 13 as an example, an information processing program 221 may be stored in a storage medium 220 which is a non-temporary storage medium. In a case of the example shown in FIG. 13, the information processing program 221 stored in the storage medium 220 is installed in the information processing apparatus 60, and the CPU 60A executes each processing described above in accordance with the information processing program 221.

Various embodiments are described above, but it goes without saying that the present invention is not limited to such examples. It is apparent that those skilled in the art may perceive various modification examples or correction examples within the scope disclosed in the claims, and those examples are also understood as falling within the technical scope of the present invention. Each constituent in the above embodiment may be adopted in any combination without departing from the gist of the invention.

The present application is based on Japanese Patent Application (JP2023-185446) filed on Oct. 30, 2023, the content of which is incorporated in the present application by reference.

### EXPLANATION OF REFERENCES

1: imaging system
10: imaging apparatus
10a: imaging apparatus position
11: personal computer
12: communication line
13a, 43B: display
13b: keyboard
13c: mouse
14: secondary storage device
15: optical system
15B: lens group
15B1: anti-vibration lens
15B2: zoom lens
16: revolution device
17, 21: lens actuator
19: computer
22: BIS driver
23: OIS driver
25: imaging element
25A: light-receiving surface
27: imaging element actuator
28: lens driver
29, 45: correction mechanism
31: DSP
32: image memory
33: correction unit
34, 66, 68, 78: communication I/F
35, 60C: memory
36, 60B: storage
37, 60A: CPU
38, 69: bus
39, 47: position sensor
40: shake amount detection sensor
43: UI system device
43A, 62: reception device
60: information processing apparatus
71: yaw-axis revolution mechanism
72: pitch-axis revolution mechanism
73, 74: motor
75, 76: driver
81, 82: power transmission tower
82a: power transmission line holding portion
91: power transmission line
92: defective location
100: distance information
101a, 101b, 101c, 101d, 101e: divided captured image
110: vertical surface
120: circle
220: storage medium
221: information processing program
D1, D2: distance
A1, A2: end part

What is claimed is:

1. An information processing apparatus comprising:
a processor that is communicable with an imaging apparatus and a revolution device causing the imaging apparatus to revolve,
wherein the processor is configured to:
acquire first position information based on a revolution condition of the revolution device corresponding to a first subject;
acquire second position information based on a revolution condition of the revolution device corresponding to a second subject;
acquire third position information based on a revolution condition of the revolution device corresponding to a third subject; and
output distance information between the first subject and one of the second subject or the third subject that is closer to the imaging apparatus, based on the first position information, the second position information, and the third position information,
wherein captured images of the first subject, the second subject and the third subject, captured by the imaging apparatus, are obtained by different imaging operations, respectively.

2. The information processing apparatus according to claim 1,
wherein the captured images are a plurality of divided captured images sequentially captured in accordance with an imaging condition of the imaging apparatus.

3. The information processing apparatus according to claim 1,
wherein the first subject, the second subject, and the third subject are present on a first surface.

4. The information processing apparatus according to claim 1,
wherein the processor is configured to:
acquire the first position information based on the revolution condition of the revolution device corresponding to the first subject and an imaging condition of the imaging apparatus;
acquire the second position information based on the revolution condition of the revolution device corresponding to the second subject and an imaging condition of the imaging apparatus; and
acquire the third position information based on the revolution condition of the revolution device corresponding to the third subject and an imaging condition of the imaging apparatus.

5. The information processing apparatus according to claim 1,
wherein the second subject is a subject closer to the imaging apparatus than the third subject, and
the processor is configured to:
acquire the second position information based on the revolution condition of the revolution device corresponding to the second subject and an imaging condition of the imaging apparatus; and
acquire the third position information based on the revolution condition of the revolution device corresponding to the second subject and the imaging condition of the imaging apparatus, and the revolution condition of the revolution device corresponding to the third subject.

6. The information processing apparatus according to claim 1,
wherein the second subject is a subject closer to the imaging apparatus than the third subject, and
the processor is configured to:
acquire the second position information based on the revolution condition of the revolution device corresponding to the second subject and an imaging condition of the imaging apparatus; and
acquire the third position information based on the second position information, a distance between the second subject and the third subject, and the revolution condition of the revolution device corresponding to the third subject.

7. The information processing apparatus according to claim 5,
wherein the first subject, the second subject, and the third subject are present on a first surface, and
the processor is configured to acquire the first position information based on the second position information, the third position information, and the revolution condition of the revolution device corresponding to the first subject.

8. The information processing apparatus according to claim 5,
wherein the processor is configured to determine that the second subject is closer to the imaging apparatus than the third subject based on an imaging condition of the imaging apparatus corresponding to the second subject and an imaging condition of the imaging apparatus corresponding to the third subject.

9. The information processing apparatus according to claim 5,
wherein the processor is configured to acquire the third position information based on information indicating a relative height relationship between the second subject and the third subject.

10. The information processing apparatus according to claim 1,
wherein the revolution condition of the revolution device includes at least one of a pan state or a tilt state of the revolution device.

11. The information processing apparatus according to claim 1,
wherein an imaging condition of the imaging apparatus includes focus information of the imaging apparatus.

12. A control device that controls the imaging apparatus and/or the revolution device based on information generated by the information processing apparatus according to claim 1.

13. An information processing method performed by an information processing apparatus including a processor that is communicable with an imaging apparatus and a revolution device causing the imaging apparatus to revolve, the method comprising:
via the processor,
acquiring first position information based on a revolution condition of the revolution device corresponding to a first subject;
acquiring second position information based on a revolution condition of the revolution device corresponding to a second subject;
acquiring third position information based on a revolution condition of the revolution device corresponding to a third subject; and
outputting distance information between the first subject and one of the second subject or the third subject that is closer to the imaging apparatus, based on the first position information, the second position information, and the third position information,
wherein captured images of the first subject, the second subject and the third subject, captured by the imaging apparatus, are obtained by different imaging operations, respectively.

14. A non-transitory computer readable medium storing an information processing program by an information processing apparatus including a processor that is communicable with an imaging apparatus and a revolution device causing the imaging apparatus to revolve, the program causing the processor to execute a process comprising:
acquiring first position information based on a revolution condition of the revolution device corresponding to a first subject;
acquiring second position information based on a revolution condition of the revolution device corresponding to a second subject;
acquiring third position information based on a revolution condition of the revolution device corresponding to a third subject; and
outputting distance information between the first subject and one of the second subject or the third subject that is closer to the imaging apparatus, based on the first position information, the second position information, and the third position information,
wherein captured images of the first subject, the second subject and the third subject, captured by the imaging apparatus, are obtained by different imaging operations, respectively.

15. An imaging system comprising: the information processing apparatus according to claim 1; the imaging apparatus and the revolution device.
